(19) United States
(12) Patent Application Publication
(10) Pub. No.: US 2009/0151168 A1
(43) Pub. Date: Jun. 18, 2009

(54) CUTTING TOOL FOR PACKAGING

(76) Inventor: Jeffry Dadam, Bellevue, WA (US)

Correspondence Address: DAVIS WRIGHT TREMAINE, LLP/Seattle, 1201 Third Avenue, Suite 2200, SEATTLE, WA, 98101-3045, US

(21) Appl. No.: 11/959,226

(22) Filed: Dec. 18, 2007

(51) Int. Cl. B26B 11/00; B26B 1/08

(52) U.S. Cl. 30/146; 30/151; 30/162; 30/337

(57) ABSTRACT

A cutting tool configured to cut packaging. The tool includes a handle and a blade having a cutting portion. The blade is affixed to the handle with the cutting portion extending outwardly from the handle. The cutting portion of the blade resides inside a retractable sheath that is movable between a blade guarding position and a blade exposing position. The sheath is coupled to the handle by a biasing assembly that biases the sheath into the blade guarding position whereat the cutting portion of the blade is received completely inside the sheath. The sheath retracts to the blade exposing position when the sheath is pressed against the packaging with sufficient force to overcome the biasing force applied thereto by the biasing assembly. When the sheath is retracted, the cutting portion of the blade is placed into contact with the packaging against which the sheath is pressed.

### BACKGROUND OF THE INVENTION

1. Field of the Invention

The present invention is directed generally to cutting tools and more particularly to cutting tools configured to cut packaging, such as the packaging used to protect, store, and/or ship consumer goods.

2. Description of the Related Art

A common frustration experienced by many consumers is freeing a newly purchased item from its packaging. This packaging may include “clamshell” type packaging, blister packaging, cardboard boxes, and the like. Exemplary prior art packages may be viewed in FIGS. 7-13A of published U.S. patent application Ser. No. 10/906,443 published under Publication No. U.S. 2005/0102838.

Clamshell type packaging typically includes thick resilient sheets of plastic permanently fastened together by crimping, gluing, melting, and the like. Such packaging frequently includes a pair of juxtaposed sheets of plastic permanently affixed together along their matched peripheral edges. Because the edges of the package are sealed together, the user cannot simply pry the sheets apart to free the item. Other packages include a plastic sheet that is glued or otherwise affixed to a sheet a cardboard. Typically, the plastic sheet is contoured to accommodate the item housed inside the package. Often, the item is coupled to the packaging by fasteners, such as plastic ties, wire twist ties, rubber bands, and the like.

To reduce the bulk of and volume occupied by the packaging, the packaging may be fitted close to the item stored inside. Packaging is frequently contoured to follow the outer shape of products stored therein making it difficult to cut the surrounding packaging while avoiding cutting the item stored inside. Cutting the packaging is further complicated when it has a smooth outer surface which may cause a cutting tool, such as a knife to slip thereupon during cutting potentially injuring its user and/or damaging the item inside.

In addition to protecting the item inside, packaging typically helps advertise the item and provides a pleasing presentation to the purchaser. Therefore, the packaging and the materials used to construct it may be substantially resistant to damage, e.g., wear resistant, water resistant, impact resistant, tear resistant, puncture resistant, and resistant to other types of damage. Obviously, such damage resistant packaging resists the purposeful attempts of the purchaser to open it. Further, packaging designers seem to give little or no consideration to how consumers may ultimately be open the packaging.

Currently, consumers generally open packaging by cutting it with a knife (such as a razor knife, box cutter, kitchen knife, and the like), razor blade, scissors, and the like. However, as mentioned above, knives frequently slip on the smooth outer surfaces of the packaging creating a hazardous situation for the user. Further, a knife may cut too deeply and damage the item inside the package. A pair of scissors may not open wide enough to cut some packages or may be unable to traverse the contoured shape of the packaging. Because the packaging is often closely fitted to the item, it is sometimes difficult to insert one of blades of scissors into the packaging. Further, the cut edges of the packaging are often sharp. As the user cuts through the package with scissors, the user's hands move between a pair of cut edges potentially injuring the user. Often the user is forced to cut only a portion of the packaging and tear the remaining portion. This technique often results in the item exiting the packaging unexpectedly and thereby becoming damaged.

Therefore, it would be desirable to have a device for opening packages, such as clamshell packages, blister packages, cardboard boxes, and the like, safely and easily. It would be particularly useful, if the device could cut both the thick plastic sheets used in clamshell packaging and other types packaging as well as any fasteners used to affix the item to one or more components of the package. It would also be desirable to have a package-cutting tool that avoided damage to the item(s) inside the package.

### BRIEF DESCRIPTION OF THE SEVERAL VIEWS OF THE DRAWING(S)

FIG. 1 is a side view of an embodiment of a cutting tool constructed according to aspects of the present invention.

FIG. 2 is a side view of the cutting tool of FIG. 1 with its protective sheath positioned in the blade exposing position.

FIG. 3 is a side view of the cutting tool of FIG. 1 depicting the biasing assembly biasing the protective sheath in the blade guarding position.

FIG. 4 is a side view of the cutting tool of FIG. 1 illustrated with its protective sheath in the blade guarding position and its blade positioned to form a larger cutting portion than that depicted in FIG. 1.

FIG. 5 is a side view of the cutting tool of FIG. 1 depicting the biasing assembly biasing the protective sheath in the blade guarding position.

FIG. 6A is a side view of an alternate embodiment of the cutting tool in which the blade is mounted to a moveable cartridge assembly and the protective sheath is positioned in the blade exposing position.

FIG. 6B is a cross-sectional view of the cutting tool of FIG. 6A taken substantially along line 6B-6B.

FIG. 6C is a cross-sectional view of the cutting tool of FIG. 6A taken substantially along line 6C-6C of FIG. 6A.

FIG. 7A is a side view of an alternate embodiment of the cutting tool depicting the biasing assembly biasing the protective sheath in the blade guarding position and a lock in an unlocked position allowing the protective sheath to transition freely into and out of the blade exposing position.

FIG. 7B is an enlarged fragmentary view of a portion of FIG. 7A depicting the lock in the unlocked position.

FIG. 8A is a side view of the alternate embodiment of the cutting tool of FIG. 7A depicting the biasing assembly biasing the protective sheath in the blade guarding position and the lock in a locked position preventing the protective sheath from transitioning into the blade exposing position.

FIG. 8B is an enlargement of a portion of FIG. 8A depicting the lock in the locked position.

FIG. 9 is a side view of an alternate embodiment of the cutting tool in which the blade is mounted in a substantially stationary position within a handle portion of the cutting tool and the protective sheath illustrated as biased in the blade guarding position by the biasing assembly.

### DETAILED DESCRIPTION OF THE INVENTION

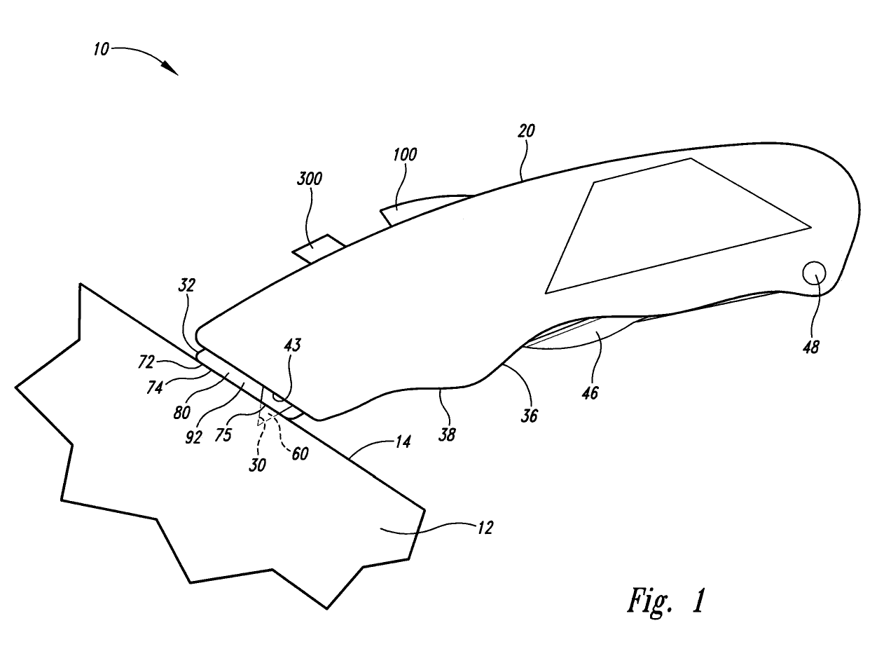

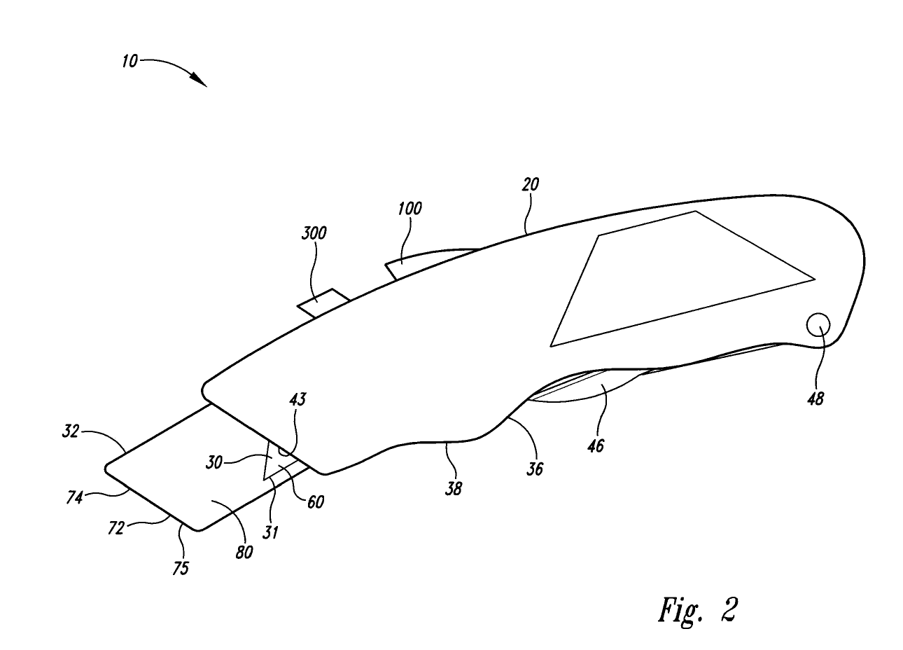

Referring to FIGS. 1 and 2, aspects of the present invention include a cutting tool 10 configured to open a package 12, such as a “clamshell” type package, blister package, cardboard box, and the like. The package 12 has an outer surface 14, which may be smooth, glossy, slippery, and the like.

The cutting tool 10 may be constructed to cut both the thick plastic sheets used to construct “clamshell” type packaging and other types of packaging as well as the fasteners, such as plastic ties, wire twist ties, rubber bands, and the like that may be used to affix an item to one or more of the plastic sheets or other components of the package. The cutting tool 10 includes a handle portion 20, an extendible blade 30, and a retractable protective sheath 32.

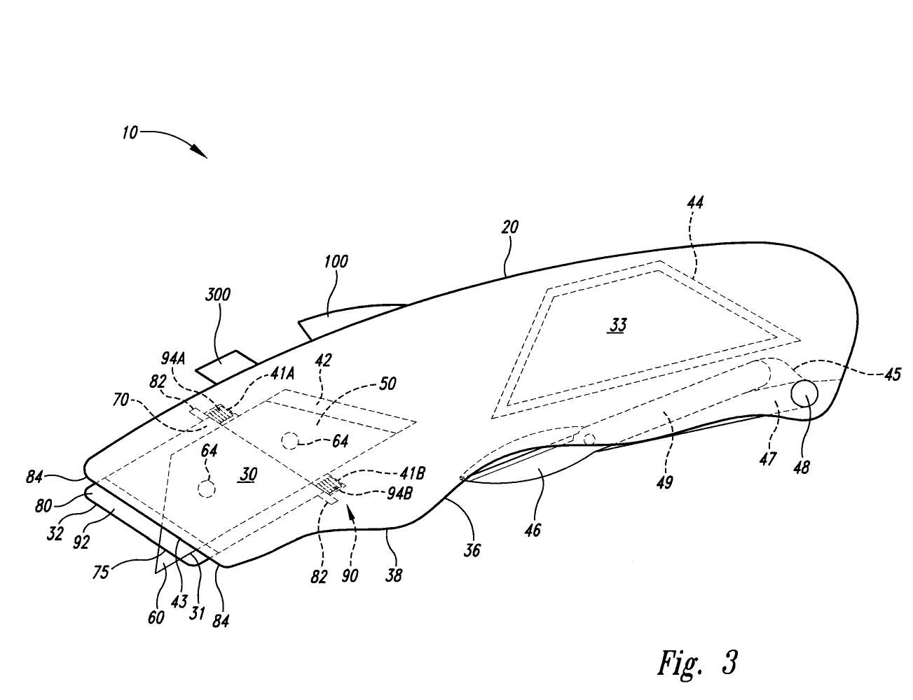

Referring to FIG. 3, the handle portion 20 includes a grip portion 36 which may include a contoured surface 38 configured to conform to the shape of a hand of the user. The handle portion 20 may include one or more internal walls (e.g., internal walls 41A and 41B) to which various internal components of the cutting tool 10 may be mounted. The internal walls may define a hollow portion 42 configured to house various internal components of the cutting tool 10. The handle portion 20 includes an aperture 43 that provides a passageway or throughway between the hollow portion 42 and the exterior of the handle portion 20. The hollow portion 42 may include internal structures (not shown) such as rails or guides configured to accommodate the protective sheath 32 and/or facilitate its movement within the hollow portion 42 (described below). Optionally, the handle portion 20 may include one or more internal compartments 44 in which spare blades 33 may be stored.

The handle portion 20 may be constructed using any method known in the art for constructing a handle of a cutting tool. For example, the handle portion 20 may be constructed from metals such as steel, aluminum, and the like or plastics. The grip portion 36 may be constructed using metal, plastic, rubber, and the like. The handle portion 20 may include two or more portions that are fastened together using any method known in the art. For example, the handle portion 20 may be formed from the assembly of a left portion (as shown in FIGS. 1-6A, 7A, 8A and 9) and right portion (not shown) but of similar construction as the left portion. The left portion and right portion are determined relative to the hand of the user. The left and right portions may be fastened together to form the assembled handle portion 20 using any method known in the art including screws, bolts, and the like. The internal walls 41A and 41B may extend laterally between the left and right portions of the handle portion 20. The handle portion 20 may be sized and shaped to be held in an adult hand. Because adult hand size varies between individuals, the size of the handle portion 20 may be determined by the user. By way of non-limiting example, the handle portion may be about 6 inches to about 8 inches long, about 1 inch to about 1.5 inches tall, and about 0.25 inches to about 0.75 inches wide.

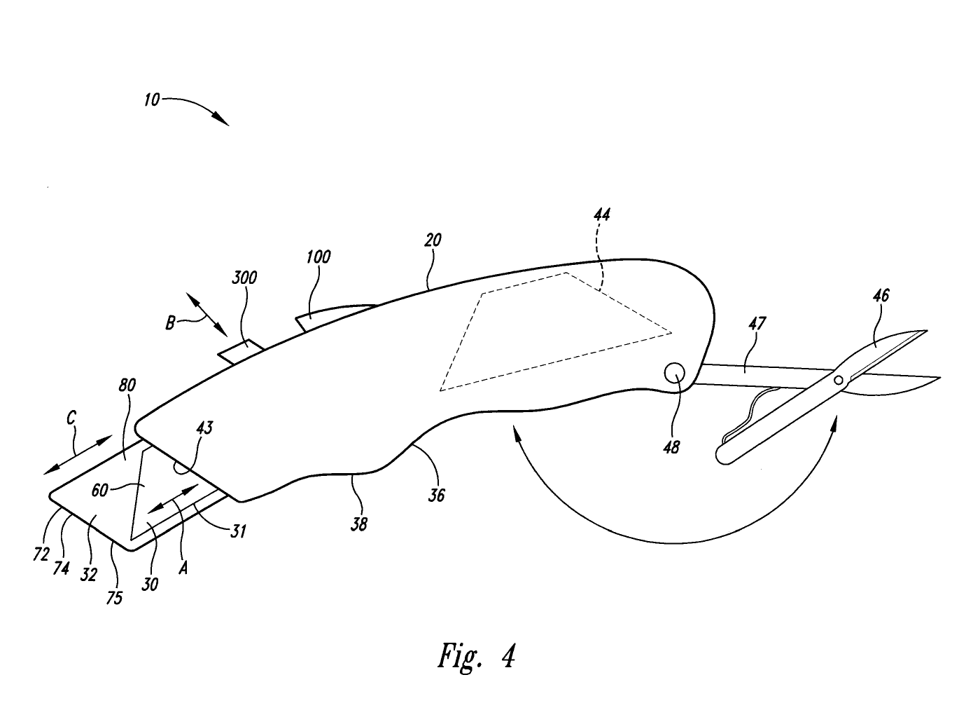

Optionally, the handle portion 20 may include a recess 45 configured to receive a pair of scissors 46. A handle 47 of the optional pair of scissors 46 may be pivotally mounted to the handle portion 20 by a pivot pin 48 located near one end of the recess 45 and positioned to pivot the scissors 46 from a closed position (shown in FIGS. 1-3) in which a portion 49 of the scissors 46 are received into the recess 45 for storage and an operating position in which the scissors 46 are pivoted out of the recess 45 (as shown in FIG. 4) for use. Those of ordinary skill in the art appreciate, that structures for mounting a pair of scissors to a cutting tool are well known in the art and the invention is not limited to the techniques described herein. The scissors 46 may be used to cut fasteners, such as plastic ties, wire twist ties, rubber bands, and the like. The scissors 46 may be constructed using any suitable material known in the art including steel.

The blade 30 may include any blade known in the art including a razorblade having a single cutting edge, an Exacto-knife blade, a razorblade having two cutting edges, a breakaway blade, a trapezoidal-shaped blade of the type typically used in utility knives, and the like. Blades used in cutting tools, such as the cutting tool 10, are well-known in the art and the present invention is not limited to a particular type of blade. By way of non-limiting example, the blade 30 may be generally trapezoidal in shape and may include a single cutting edge 31.

The blade 30 includes an anchor portion 50 disposed inside the handle portion 20 and a cutting portion 60 that extends outside the handle portion 20 through the aperture 43 as seen in FIG. 3. The anchor portion 50 is affixed inside the hollow portion 42 of the handle portion 20. As is appreciated by those of ordinary skill, blades often include through-holes, cutout portions, flanges, or other structures configured to facilitate the mounting of the blade to a cutting tool. In some cases, such structures are used to secure the blade to the cutting tool. By way of non-limiting example, the blade 30 may include one or more spaced apart apertures 64.

The depth of the cut achievable by the cutting tool 10 may be determined by selecting the amount of the blade 30 that extends outside the handle portion 20 through the aperture 43 and is thereby available to form the cutting portion 60. For example, a deep cut may be achieved by affixing the anchor portion 50 inside the hollow portion 42 at a location or in a manner that allows a large portion of the blade 30 to extend outside the hollow portion 42 through the aperture 43 (e.g., see FIG. 4). A shallower cut may be achieved by reducing the size of the portion of the blade 30 to extend outside the hollow portion 42 through the aperture 43 (e.g., see FIGS. 1-3).

As is apparent to those of ordinary skill in the art, the blade 30 may be symmetric about an axis perpendicular to the cutting edge 31. In such embodiments, the anchor portion 50 of the blade 30 may be mounted to the handle portion 20 with the cutting portion 60 extending out of the hollow portion 42 through the aperture 43 as shown in the figures. When the cutting portion 60 becomes worn, the blade 30 may be flipped 180 degrees and remounted to the handle portion 20 with its opposite end serving as the cutting portion 60. In this flipped orientation, a portion (not shown) of the original cutting portion 60 forms a new anchor portion and a portion (not shown) of the original anchor portion 50 becomes the new cutting portion.

The protective sheath 32 includes an anchor portion 70 disposed inside the hollow portion 42 of the handle portion 20 and a guard portion 80 that extends outside the handle portion 20 through the aperture 43. The protective sheath 32 is hollow and has an exteriorly opening end as will be described below. The guard portion 80 is configured to receive the cutting portion 60 of the blade 30 therein. The protective sheath 32 is configured to move between a blade guarding position (depicted in FIGS. 2, 4, 5, 7A, 8A, and 9) in which the cutting portion 60 resides entirely inside the guard portion 80 of the protective sheath 32 and a blade exposing position (depicted in FIGS. 1, 3, and 6A) in which the cutting portion 60 extends beyond the guard portion 80 of the protective sheath 32 and may be exposed to the outer surface 14 of the package 12. Referring to FIG. 4, the protective sheath 32 may move between these two positions in the directions indicated by double-ended arrow “C.” The guard portion 80 shields the user from the cutting portion 60 of the blade 30 when the protective sheath 32 is in the blade guarding position. The cutting tool 10 is operable to cut packaging using the cutting portion 60 of the blade 30 when the protective sheath 32 is in the blade exposing position.

Returning to FIG. 3, the anchor portion 70 of the protective sheath 32 may optionally include a stop flange 82 configured to bear against a portion 84 of the inside of the hollow portion 42 when the protective sheath 32 is in the blade guarding position to prevent removal of the protective sheath 32 from the handle portion 20 via the aperture 43. Optionally, the portion 84 of the inside of the hollow portion 42 may be adjacent to the aperture 43.

The anchor portion 70 of the protective sheath 32 is coupled to a biasing assembly 90 configured to bias the protective sheath 32 into the blade guarding position (e.g., see FIG. 2) in which the cutting portion 60 resides entirely inside the protective sheath 32. The biasing assembly 90 maintains the protective sheath 32 in the guarding position when the cutting tool 10 is not in use.

Referring to FIGS. 1 and 3, the guard portion 80 of the protective sheath 32 includes a package-engaging portion 72 formed along its distal edge 74. The package-engaging portion 72 includes an opening 75 through which the cutting portion 60 of the blade 30 exits the protective sheath 32 when the protective sheath 32 is in the blade exposing position. The package-engaging portion 72 is configured to be pressed against the outer surface 14 of the package 12. When the package-engaging portion 72 is pressed against the outer surface 14 of the package 12 with sufficient force, the biasing force applied to the anchor portion 70 by the biasing assembly 90 is overcome and the protective sheath 32 is forced into the hollow portion 42 of the handle portion 20 through the aperture 43 thereby positioning the protective sheath 32 in the blade exposing position. As exposed, the cutting portion 60 of the blade 30 is pressed into greater engagement with the package 12. Because pressing the protective sheath 32 against the package 12 is required to transition the protective sheath 32 into the blade exposing position, the cutting portion 60 of the blade 30 is not exposed above the outside surface 14 of the package 12. A portion 92 of the guard portion 80 may remain outside the handle portion 20. The portion 92 may shield any portion of the blade 30 that is located between the handle portion 20 and the outside surface 14 of the package 12. The protective sheath 32 may be constructed using any suitable material known in the art including plastics such as clear plastic materials.

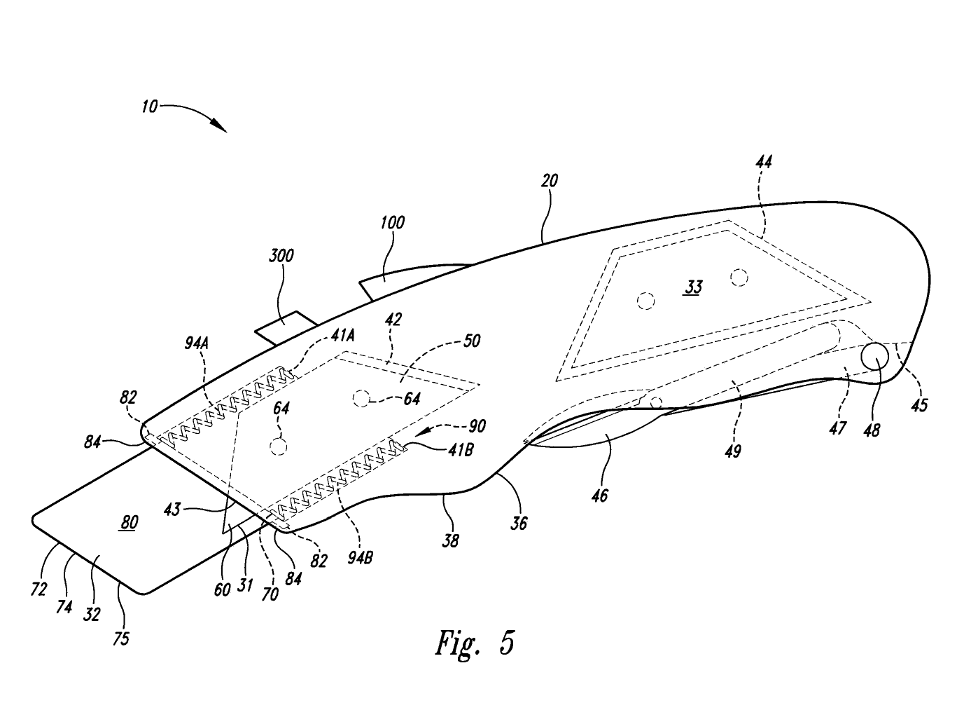

Referring to FIGS. 3 and 5, the biasing assembly 90 may include a biasing member 94A such as a spring. In the embodiment depicted in FIGS. 3 and 5, the biasing assembly 90 includes a pair of biasing members 94A and 94B each mounted to one of the internal walls 41A and 41B, respectively, of the handle portion 20. The biasing members 94A and 94B are also coupled to the anchor portion 70 of the protective sheath 32. In the embodiment depicted in FIGS. 3 and 5, the biasing members 94A and 94B are located between the anchor portion 70 and the internal walls 41A and 41B, respectively.

An inwardly directed force is applied to the protective sheath 32 when its package-engaging portion 72 is pressed against the package 12. This force is translated by the protective sheath 32 to the biasing members 94A and 94B. The inwardly directed force compresses the biasing members 94A and 94B against internal walls 41A and 41B, respectively, allowing the protective sheath 32 to move inwardly toward the internal walls 41A and 41B exposing the cutting portion 60 of the blade 30 for cutting the package 12. When the inwardly directed force is removed, the outward biasing force provided by the biasing members 94A and 94B move the sheath 32 outward toward the blade guarding position.

While the biasing members 94A and 94B are illustrated as coil compression springs in the drawings, it is apparent to those of ordinary skill in the art that alternate structures may be used that deflect or deform when greater than a predetermined amount of force is applied thereto and revert to their original shape when the amount of force applied is reduced below the predetermined amount. For example, the compression springs may be replaced with one or more solid members (not shown) constructed from compressible materials such as foam, rubber, and the like.

Other non-limiting examples of suitable structures for constructing biasing members 94A and 94B include other types of springs such as cantilever springs, and the like. A cantilever spring (not shown) may be coupled by one of its ends to the inside of the hollow portion 42. The other end of the cantilever spring may abut the anchor portion 70 and bias the protective sheath 32 toward the blade guarding position. Force applied to the protective sheath 32 may press upon the end of the cantilever spring abutting the anchor portion 70 deflecting the cantilever spring inward allowing the protective sheath 32 to move into the blade exposing position. When the force is no longer applied or is reduced below the predetermined amount, the cantilever spring may return to its original position thereby biasing the protective sheath 32 back into the blade guarding position.

Further, elastic or stretchable members such as tension springs, rubber bands, and the like, may be used to construct biasing members 94A and 94B. By way of non-limiting example, one or more elastic members (not shown) may be operably mounted to both the inside of the hollow portion 42 and the anchor portion 70 of the protective sheath 32. The elastic member(s) may be in a relaxed position when the protective sheath 32 is in the blade guarding position. When a sufficient inward force is applied to the protective sheath 32 by pressing it against the package 12, the elastic member(s) may stretch allowing the protective sheath 32 to move to the blade exposing position and creating a return biasing force capable of returning the sheath toward the blade guarding position when the inward force is reshaped or released.

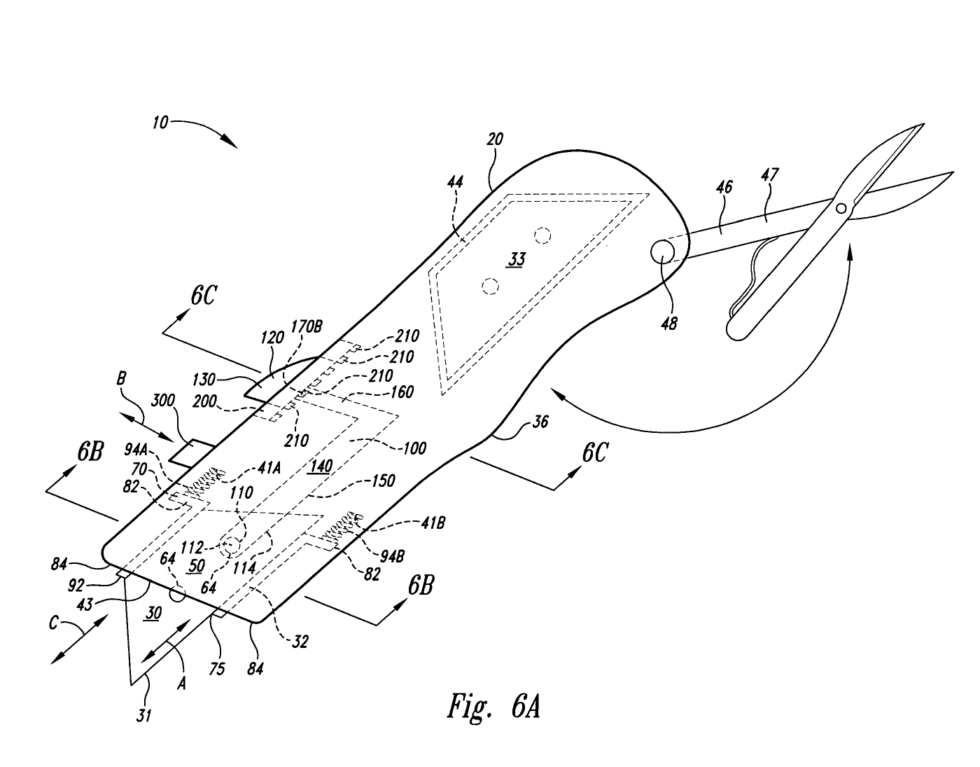

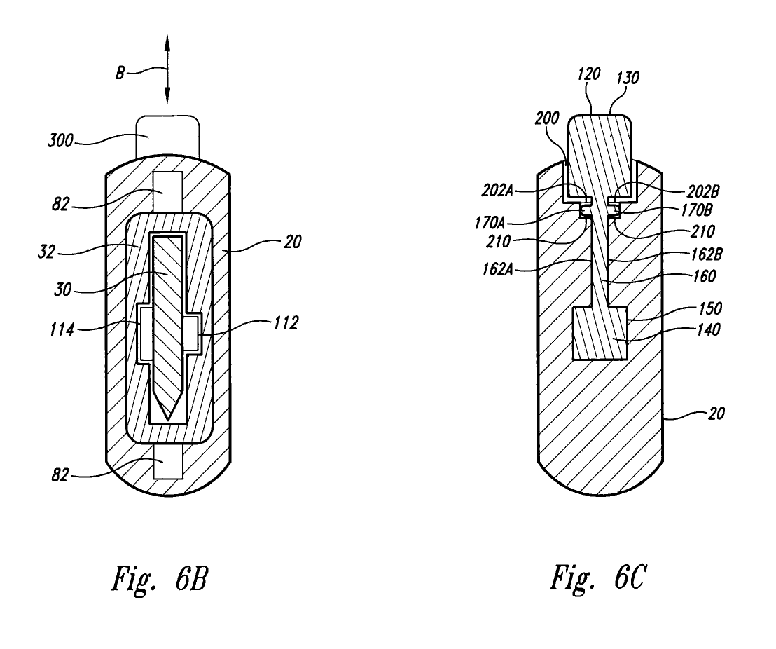

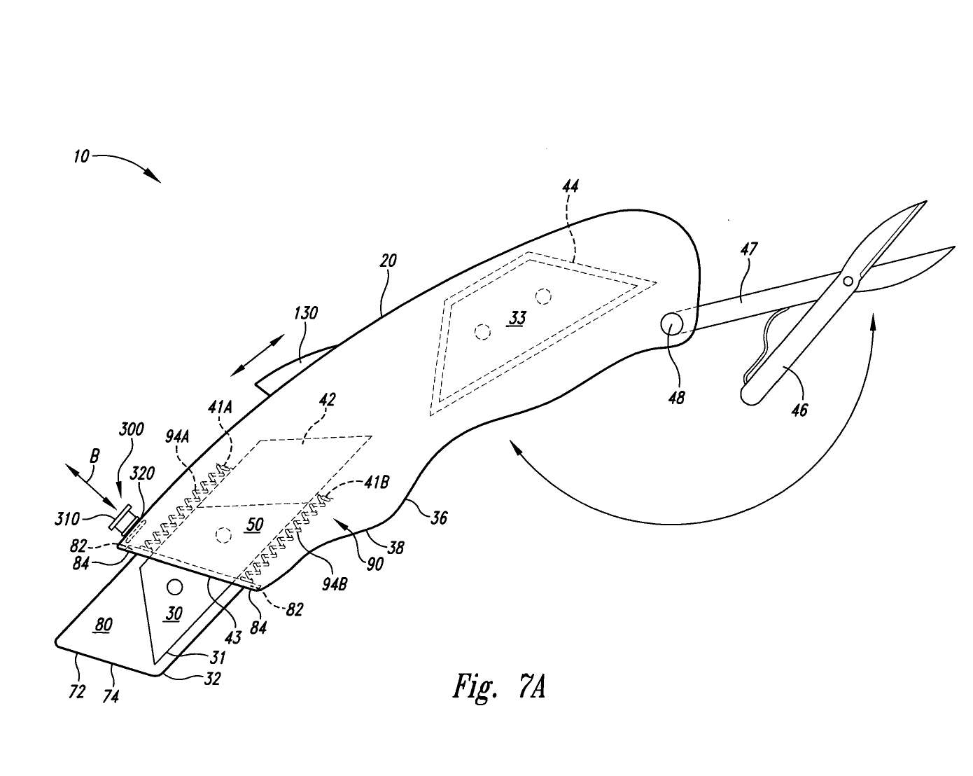

FIGS. 6A-6C illustrate an embodiment of an optional moveable cartridge assembly 100 configured to move the blade 30 relative to the aperture 43 thereby adjusting the amount of the blade 30 extending outwardly from the aperture 43 to form the cutting portion 60. The moveable cartridge assembly 100 may move the blade 30 forward and backward in the directions indicated by double-ended arrow “A.”

The moveable cartridge assembly 100 includes a connector portion 110 configured to be removably coupled to the blade 30. In the embodiment depicted in FIGS. 6A-6C, the connector portion 110 includes a peg 112 configured to be inserted into one of the apertures 64 of the blade 30. The connector portion 110 may also include a support portion 114 configured bear against one side of the blade 30 to help prevent the blade 30 from pivoting inside the hollow portion 42 and/or the aperture 43.

The moveable cartridge assembly 100 includes a user interface 120 having a button 130, such as conventional thumb button, coupled to the connector portion 110 by a slidable member 140. The slidable member 140 may be oriented along the direction of travel (the same directions are indicated by double-ended arrow “A”) of the moveable cartridge assembly 100. The hollow portion 42 may include an interior channel 150 within which the slidable member 140 may slide.

The button 130 may be coupled to the slidable member 140 by a connecting member 160. One or more bumps or projections 170 may be formed along opposing sides 162A and 162B of the connecting member 160 toward its end portion to which the button 130 is attached. In the embodiments depicted in FIGS. 6A-6C, the connecting member 160 is approximately orthogonal to the slidable member 140. However, as is appreciated by those of ordinary skill in the art, the connecting member 160 may be connected to the slidable member 140 in arrangements other than orthogonal and such embodiments are within the scope of the present invention.

The handle portion 20 may include a slot 200. The button 130 and/or the connecting member 160 may slide within the slot 200. The inward, opposing longitudinal edges 202A and 202B of the slot 200 may include a plurality of juxtaposed recesses 210. The juxtaposed recesses 210 being configured to receive the projections 170 formed along opposing sides 162A and 162B of the connecting member 160. In the embodiment depicted in FIGS. 6A--6C, each of the opposing sides 162A and 162B of the connecting member 160 includes a single projection 170A and 170B, respectively. The juxtaposed recesses 210 are arranged in pairs, each recess 210 having a corresponding recess juxtaposed therewith across the slot 200.

The projections 170A and 170B may be seated within a first pair of juxtaposed recesses 210 of the slot 200. The projections 170A and 170B may be removed from the first pair of juxtaposed recesses 210 by pushing the button 130 inward in the directions indicated by arrow “B” of FIG. 6B. After removal from the first pair of juxtaposed recesses 210, the projections 170 and 170B may be seated within a selected other pair of juxtaposed recesses 210 by continuing to push the button 130 inward while also pushing the button in one of the directions indicated by double-ended arrow “D” until the projections 170 are aligned with the selected pair of juxtaposed recesses 210 and then releasing the inward force on the button 130. In this manner, the position of the blade 30 relative the aperture 43 may be selected.

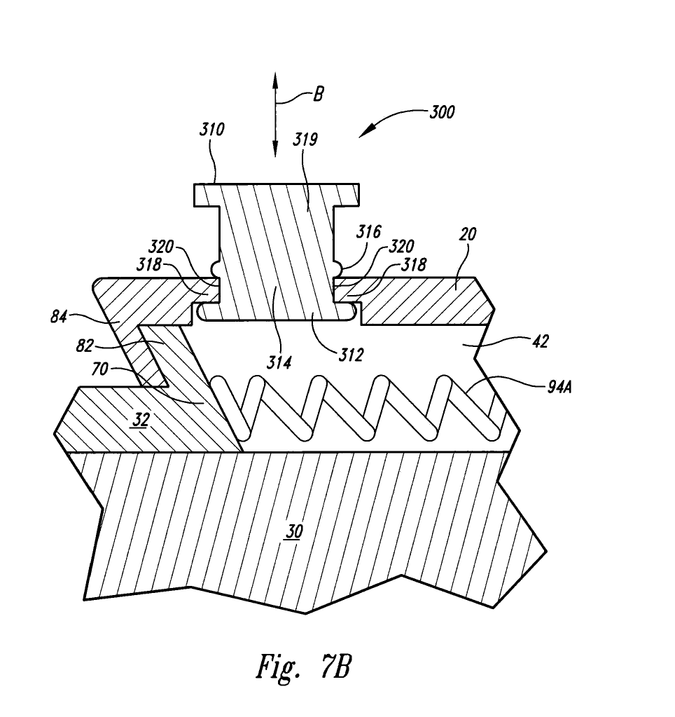

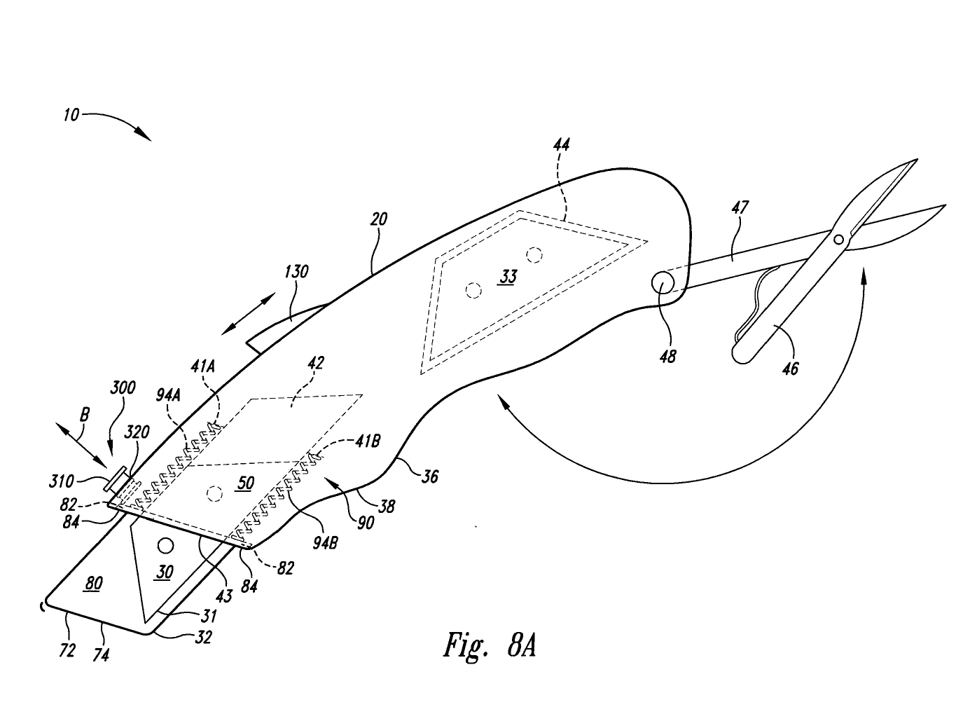

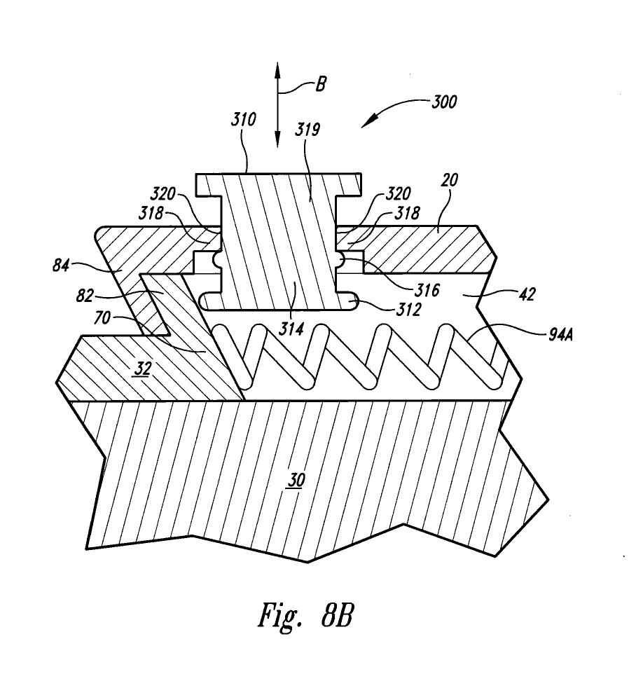

Referring to FIGS. 7A-8B, the cutting tool 10 may include a lock 300 configured to transition between a locked position (shown in FIGS. 8A and 8B) and an unlocked position (shown in FIGS. 7A and 7B). When the lock 300 is in the unlocked position, the protective sheath 32 transitions freely between the blade guarding position and the blade exposing position. However, when the lock 300 is moved inward into the locked position, the protective sheath 32 is prevented from transitioning between the blade guarding position and the blade exposing position.

Turning to FIGS. 7A-7B, the lock 300 may include a button 310 having an inward end portion 312 located inside the hollow portion 42 and a shaft portion 314 disposed inside a through-hole 320 formed in the handle portion 20. The shaft portion 314 is configured to slide inside the through-hole 320 along the directions indicated by double-ended arrow “E.” The shaft portion 314 may include a protruding stop portion 316 configured to bear against the outside surface of a portion 318 of the handle portion 20 adjacent the through-hole 320 and thereby maintaining the button 310 in the unlocked position. The button 310 may be transitioned to the locked position by pressing the button toward the handle portion 20 with sufficient force to press the stop portion 316 through the through-hole 320 and into the hollow portion 42.

Turning to FIGS. 8A-8B, after the button 310 is pressed into the through-hole 320, the end portion 31 2 thereof interferes with the free inward travel of the protective sheath 32. In the embodiment depicted, the flange 82 of the protective sheath 32 is prevented from traveling inward into the hollow portion 42 by the end portion 312. The stop portion 316 may be configured to bear against the inside surface of the portion 318 of the handle portion 20 adjacent the through-hole 320 and thereby maintain the button 310 in the locked position.

The button 310 may be transitioned from the locked position to the unlocked position by pulling the button 310 away from the handle portion 20 with sufficient force to pull the stop portion 31 6 through the through-hole 320 and out of the hollow portion 42. The end portion 312 may include a flange portion 322 that is too large to be removed from the hollow portion 42 through the through-hole 320. In the embodiment depicted, the button 310 includes a grip flange portion 324 that remains outside the handle portion 20 and provides a means by which the user may grasp the button 310 and pull it away from the handle portion 20. The grip portion 324 may be too large to be pressed into the hollow portion 42 through the through-hole 320.

In various embodiments, the lock 300 may be characterized as a child lock or similar safety device. In such embodiments, the lock 300 may be configured to make transitioning it from the locked position to the unlocked position to require sufficient force as to be difficult or impossible for children. This feature may be particularly useful during holidays, such as Christmas, when there are often many impatient children waiting for one or more packages to be opened. Because children are often curious, impatient, and/or wanting to do things themselves, this feature could prevent an accident resulting from use of the cutting tool 10 by a child. Such a lock would also tend to discourage children from playing with the cutting tool 10.

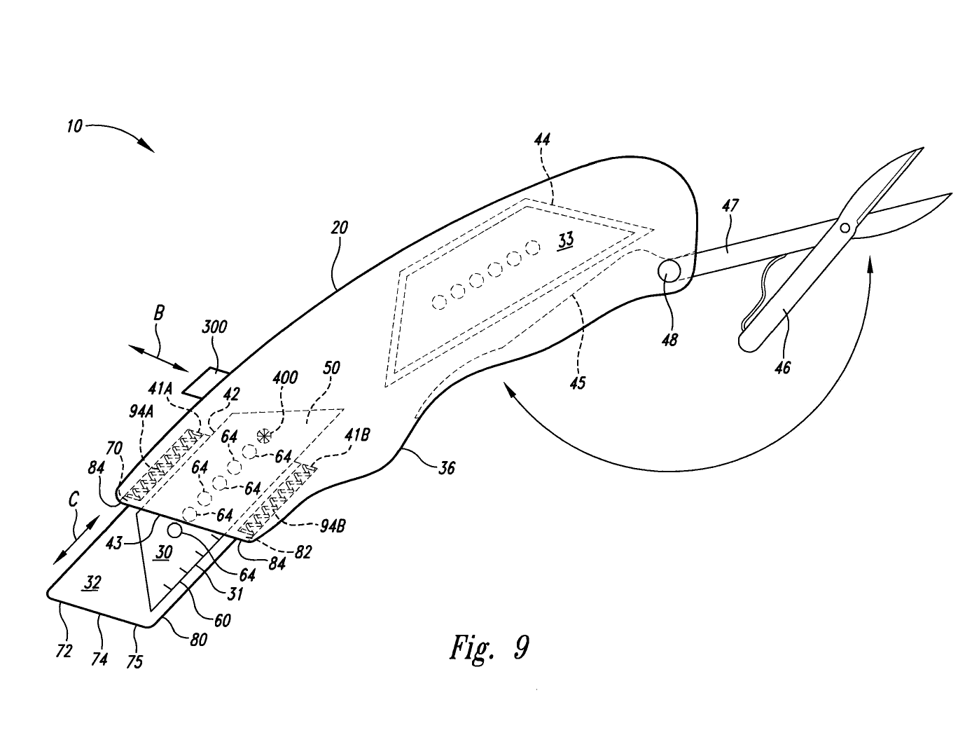

Referring to FIG. 9, an alternate embodiment is provided. In this embodiment, the blade 30 is removably mounted in a stationary position within the hollow portion 42 of the handle portion 20. The blade 30 in this embodiment is elongated and includes a plurality of spaced apart apertures 64 arranged along its longitudinal axis. The hollow portion 42 includes a peg 400 configured to be received inside a selected one of the apertures 64. The position of the blade 30 is determined by the selection of the aperture 64 into which the peg 400 is inserted. The aperture 64 selected may be modified by opening the hollow portion of the handle portion 20, lifting the blade 30 to remove it from the peg 400, moving the blade along its longitudinal axis, and inserting the peg 400 into a different aperture 64.

In the embodiments depicted in the figures, various components of the cutting tool 10 are illustrated as residing inside the hollow portion 42. For example, the anchor portion 50 of the blade 30, the anchor portion 70 of the protective sheath 32, and the biasing assembly 90 are all depicted as residing inside the hollow portion 42. Further, the protective sheath 32 is depicted as retracting (at least partially) into the hollow portion 42 when transitioning from the blade guarding position to the blade exposing position. However, as is appreciated by those of ordinary skill, many of these components may be mounted elsewhere on the handle portion 20 and the invention is not limited by the location selected. For example, the anchor portion 70 of the protective sheath 32 may be mounted to the outside of the handle portion 20 and the protective sheath 32 may retract along the outside thereof. In such an embodiment, the biasing assembly 90 or portions thereof may also be mounted to the outside of the handle portion 20. Further, the anchor portion 50 of the blade 30, the anchor portion 70 of the protective sheath 32, and the biasing assembly 90 may be mounted to the outside of the handle portion 20.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A cutting tool for cutting a package, comprising:
a handle portion;
a blade having an attachment portion attached to the handle portion and a cutting portion extending away therefrom; and
a retractable sheath movable between an blade guarding position and a blade exposing position and coupled to the handle portion by a biasing assembly that applies a biasing force to the retractable sheath biasing it into the blade guarding position whereat the cutting portion of the blade is received completely inside a portion of the retractable sheath,
the retractable sheath being configured to retract selectively to the blade exposing position when the retractable sheath is pressed against the package with a sufficient force to overcome the biasing force applied thereto by the biasing assembly and cause the retractable sheath to retract, exposing a portion of the cutting portion of the blade, and placing the portion of the cutting portion in contact with the package.

2. The cutting tool of claim 1, further comprising a movable blade mounting assembly mounted to the handle portion and configured to position the blade relative to the handle portion to determine a size of the cutting portion extending away from the handle portion, the attachment portion of the blade being attached to the handle portion by the movable blade mounting assembly.

3. The cutting tool of claim 2, wherein the movable blade mounting assembly comprises a user interface controllable by a user to selectively move the blade relative to the handle portion to determine the size of the cutting portion.

4. The cutting tool of claim 1, wherein the handle portion comprises a hollow portion having an exit aperture and the attachment portion of the blade is attached inside the hollow portion and the cutting portion of the blade extends outside the hollow portion and away from the handle portion through the exit aperture.

5. The cutting tool of claim 1, wherein the handle portion comprises a hollow portion having an exit aperture, the retractable sheath has a first portion disposed inside the hollow portion, the retractable sheath has a second portion extending outside the hollow portion and away from the handle portion through the exit aperture, and the retractable sheath retracts into the hollow portion when the retractable sheath is pressed against the package with sufficient force to overcome the biasing force applied thereto by the biasing assembly.

6. The cutting tool of claim 1, further comprising a lock selectively positionable to prevent the retractable sheath from moving from the blade guarding position to the blade exposing position.

7. The cutting tool of claim 1, wherein the handle portion includes a recess, and the cutting tool further comprising a pair of scissors, the recess being configured to receive a portion of the pair of scissors, and the pair of scissors being pivotally mounted to the handle portion to pivot at least partially into the recess for storage and out of the recess for use.

8. A cutting tool for cutting a package, comprising:
a protective sheath having a package-engaging portion configured to be pressed against the package;
a blade disposed inside the protective sheath, and having a distal cutting portion; and
a compressible biasing assembly coupled to the protective sheath and configured to bias the protective sheath over the distal cutting portion of the blade, and to compress to expose the distal cutting portion of the blade when the package-engaging portion of the protective sheath is pressed against the package with a sufficient force.

9. The cutting tool of claim 8, further comprising a handle portion having a hollow portion with an exit aperture, wherein the blade is disposed within the exit aperture with the distal cutting portion outside the hollow portion, and the blade has an anchor portion coupled to the handle portion inside the hollow portion of the handle portion.

10. The cutting tool of claim 9, wherein the biasing assembly is disposed inside the hollow portion of the handle portion, the protective sheath is disposed inside the aperture of the hollow portion with the package-engaging portion outside the hollow portion, and the protective sheath further comprises an anchor portion disposed inside the hollow portion that is coupled to the biasing assembly therein.

11. The cutting tool of claim 8, further comprising a movable blade mounting assembly configured to determine a position the blade inside the protective sheath.

12. The cutting tool of claim 11, wherein the movable blade mounting assembly comprises a user interface controllable by a user to selectively move the blade inside the protective sheath.

13. The cutting tool of claim 8, further comprising a lock configured to prevent the compressible biasing assembly from compressing when the package-engaging portion of the protective sheath is pressed against the package with the sufficient force.

14. The cutting tool of claim 8, further comprising:
a handle portion with a recess; and
a pair of scissors, the recess being configured to receive a portion of the pair of scissors, and the pair of scissors being pivotally mounted to the handle portion to pivot at least partially into the recess for storage and out of the recess for use.

15. A cutting tool for cutting a package, comprising:
a handle portion having an hollow portion with an exit aperture;
a movable blade mounting assembly having a portion mounted inside the hollow portion of the handle portion;
a blade comprising an anchor portion mounted to the movable blade mounting assembly, the movable blade mounting assembly being operable to position the blade in a selected position by at least one of selectively advancing and selectively withdrawing the blade through the exit aperture of the handle portion to position a selected cutting portion of the blade exterior to the handle portion, and to maintain the blade in the selected position;
a protective sheath disposed around the selected cutting portion of the blade and having an opening configured to permit a portion of the selected cutting portion to pass therethrough and a package-engaging portion configured to be pressed against the package; and
a biasing assembly coupled to the protective sheath and configured to bias the protective sheath over the selected cutting portion of the blade, and when the package-engaging portion of the protective sheath is pressed against the package with a sufficient force, to allow the protective sheath to retract from around the portion of the selected portion allowing the portion to exit the protective sheath through the opening of the protective sheath, the opening of the protective sheath being configured to position the portion of the selected cutting portion to engage the package when the protective sheath is retracted by engagement between the package-engaging portion of the protective sheath and the package.

16. The cutting tool of claim 15, further comprising a sheath locking assembly configured to lock the protective sheath in a locked position whereat the protective sheath covers the selected cutting portion of the blade.

17. The cutting tool of claim 15, wherein the opening of the protective sheath is formed in the package-engaging portion.

18. The cutting tool of claim 15, further comprising a positionable member coupled to the movable blade mounting assembly and configured to move the movable blade mounting assembly along a move direction and within the hollow portion of the handle portion to selectively advance and selectively withdraw the blade through the exit aperture of the handle portion.

19. The cutting tool of claim 15, further comprising a thumb button movable along an axis and coupled to the movable blade mounting assembly and operable by a user to selectively advance and selectively withdraw the movable blade mounting assembly along the axis within the hollow portion of the handle portion to selectively advance and selectively withdraw the blade through the exit aperture of the handle portion.
